(19) United States
(12) Patent Application Publication
(10) Pub. No.: US 2026/0245816 A1
(43) Pub. Date: Aug. 20, 2026

(54) REINFORCED VACUUM INTERRUPTER ELECTRODE, AND MAKING SAME FROM CLAD COMPOSITE RAW MATERIAL STARTING STOCK

(71) Applicant: Wangpei Li, Pittsburgh, PA (US)

(72) Inventor: Wangpei Li, Pittsburgh, PA (US)

(21) Appl. No.: 19/053,415

(22) Filed: Feb. 14, 2025

(51) Int. Cl. H01H 33/664; H01H 1/02

(52) U.S. Cl. CPC H01H 33/664; H01H 1/0203

(57) ABSTRACT

A reinforced electrode is provided for a vacuum interrupter with low or no continuous current-carrying requirement. A monolithic copper bar or tube is bonded permanently with, and abutted for at least 50% of its length with, a coaxial and coextensive non-copper component along its axis, both carrying parallelly the current flowing through the vacuum interrupter. Reinforcement allows for a smaller diameter for the composite electrode, hence also a smaller diameter for the bellows. A smaller movable mass combined with lower atmospheric force exerted on the bellows reduces the need of power of the driving mechanism, saving cost and reducing size of the vacuum switching device employing the vacuum interrupter. Instead of forming the reinforced electrode structure in situ during the brazing process of the vacuum interrupter, a clad composite raw material such as copper-clad steel, titanium-clad copper, or copper-clad graphite is used as the starting stock to machine the electrode.

### BACKGROUND

### 1. Field

The disclosed concept relates to vacuum switching apparatus and, in particular, vacuum switching apparatus such as, for example, vacuum interrupters. The disclosed concept also relates to the electrodes of vacuum interrupters.

### 2. Background Information

The following is a tabulation of some prior art that presently appears relevant:

U.S. Patents

| Patent Number | Kind Code | Issue Date | Patentee |
|---|---|---|---|
| 4,079,217 | A | 1978 Mar. 14 | Oeschger |
| 8,471,166 | B1 | 2013 Jun. 25 | Glaser |
| 8,334,738 | B2 | 2012 Dec. 18 | Smith et al. |
| 11,916,369 | B2 | 2024 Feb. 27 | Smith et al. |
| 11,563,318 | B2 | 2023 Jan. 24 | Montenegro et al. |
| 12,074,004 | B2 | 2024 Aug. 27 | Tueysuez et al. |
| 2,955,181 | A | 1960 Oct. 4 | Luehring |

International Patents

| Patent Number | Kind Code | Issue Date | Patentee |
|---|---|---|---|
| EP3,465,719 | B1 | 2020 Jul. 29 | Bubel et al. |
| CN215,342,426 | U | 2021 Dec. 28 | Cao et al. |
| CN219,040,337 | U | 2023 May 16 | Feng et al. |

Vacuum interrupters generally include a pair of separable contacts encased inside a vacuum envelope that provides the vacuum environment for the proper functioning of vacuum switching. Each of the contacts is connected to external busbars outside the vacuum envelope via an electrode. The electrode has to carry the continuous electrical current without generating excessive heat and causing a problematic temperature rise. For this reason, the great majority of vacuum interrupters use oxygen free high conductivity (OFHC) copper for the electrode. One weakness of an OFHC electrode is that it becomes very soft after the high temperature brazing furnace cycle necessary for the manufacturing of a vacuum interrupter. The idea of reinforcing the copper with a steel has been shown such as in U.S. Pat. No. 4,079,217, mentioned such as in U.S. Pat. No. 8,471,166, or claimed such as in European Patent EP 3,465,719, and has recently been practiced on very large size vacuum interrupters to meet the tough mechanical demands, see e.g. Chinese Patents CN 215,342,426 and 219,040,337, as vacuum interruption technology advances into high voltage and high current applications. It has, however, not found its use in two groups of vacuum switching devices employing a small size vacuum interrupter. The first group is reclosers and fault-interrupters that are required to carry only a small continuous current at or below 200 A (see e.g. U.S. Pat. Nos. 8,334,738, 11,916,369, 11,563,318, and 12,074,004). The second group uses the vacuum interrupter as a shunt switching device that is not required to carry any continuous current (see U.S. Pat. No. 2,955,181, and Preve C. et al, “Innovative SF6 Free Switch with Shunt Vacuum Interruption Technology,” Paper No. 770, 25th CIRED, Madrid Spain, June 2019.) With only a very few exceptions, the electrodes in most commercial vacuum interrupters used in these two groups of devices are made from small diameter copper bars. Because of copper's softness, the diameter of the electrode is no longer dictated by the continuous current-carrying parameter, but rather by the mechanical strength requirements. As a result, it is disproportionately large. This in turn requires a large diameter bellows that goes around the movable electrode. This combination, of having a large diameter copper electrode and a large diameter bellows, necessitates a strong mechanism that drives the movable electrode and contact. This need for a powerful mechanism increases the cost and complexity of the entire switching device. A recloser or a fault-interrupter of the first group of devices relies on energy harvesting to charge a capacitor to power a magnetic actuator. A shunt vacuum interrupter of the second group is driven by a lever that has to be picked up and rotated by another lever (—the blade of a disconnector switch in series) driven by a motor or even manually. Because of these relatively weak driving mechanisms, it is paramount for both groups of vacuum switching devices to have a low moving mass and a low atmospheric force on the bellows in their vacuum interrupters.

There is, therefore, room for improvement in the design and manufacturing of vacuum interrupters for these two groups of vacuum switching devices.

### SUMMARY

What have failed to be understood, despite many years of commercial practices in large quantities, are:
1) for an electrode that carries only a low or no continuous current, its diameter can be made smaller (than what have been in a large quantity of existing commercial vacuum interrupters used in these devices for 15+ years) if its mechanical needs do not dictate a diameter that is larger than what the continuous current-carrying parameter requires;
2) by reinforcing an OFHC copper electrode, it can be strengthened, minimizing the possibility of it becoming bent upon repeated high impact closing actions, esp. under out-of-bound operating conditions;
3) with a smaller diameter of the movable electrode, the diameter of the bellows that goes around the movable electrode can also be smaller, which means a smaller atmospheric force, the force exerted on the bellows by the external atmosphere over the vacuum inside the vacuum interrupter;
4) the moving mass associated with the movable electrode will be smaller, not only because of the smaller diameter but also because of the use of the less dense reinforcing material of steel or titanium or graphite in place of copper;
5) the smaller moving mass combined with the lower atmospheric force will greatly reduce the demand for the power of the mechanism that drives the movable end, reducing significantly the size, cost and complexity of the entire switching device; and
6) instead of making the reinforced structure of an electrode in situ during the brazing process of the vacuum interrupter, the cost of a reinforced electrode can be further reduced by using widely available commercial clad composite raw materials such as copper-clad steel or titanium-clad copper or copper-clad graphite as the starting stock to machine the electrode. This approach fittingly takes advantage of the low or no current-carrying requirement on these two groups of vacuum switching devices, bringing in the most financial benefit.

This, saving cost and reducing size, is the essence of the disclosed concept, because it is of particular importance to these two groups of vacuum switching devices, as they compete with existing low cost and small size products.

As one aspect of the disclosed concept, a reinforced electrode is provided for a vacuum interrupter for a recloser or a fault-interrupter with a low continuous current-carrying requirement, or for a shunt vacuum interrupter that is not required to carry continuous current. Such a reinforced electrode comprises a monolithic copper piece reinforced by, and joined permanently to, a component made of a non-copper material (defined as containing no more than 10 wt. % of copper), both carrying parallelly the current flowing through the vacuum interrupter. When taken at any plane perpendicular to the axis of the tubular vacuum interrupter, the cross-section of such an electrode, for at least 50% of the length of the copper piece along that axis, has a composite structure comprising the copper piece and the non-copper reinforcing component mutually abutting (defined as the smallest gap between them being no more than 3 mm).

As one non-limiting embodiment of the disclosed concept, a stainless steel or a carbon steel or an iron, either as an outer sleeve or as an inner core of a solid copper bar or a copper tubing, is used to reinforce the soft copper, thereby allowing the diameter of the composite electrode, and hence also the inside diameter of the convolutions of the bellows, to be significantly smaller, for a vacuum interrupter with a low or no continuous current-carrying requirement.

As further non-limiting embodiments of the disclosed concept, titanium or graphite is used as the reinforcing material to the soft copper, to minimize the moving mass while maintaining an adequate mechanical strength of the electrode.

As another aspect of the disclosed concept, a reinforced electrode made from a clad composite raw material starting bar stock is provided. The clad composite raw material can have either a solid core or a tube as the inside component. The cross-section of the clad material can be of either a circular or a non-circular shape. Cladding methods used to form the clad material include but are not limited to: electroplating, electroless plating, explosive welding, roll bonding, extruding, hot isostatic pressing, laser cladding, thermal spraying, and diffusion bonding. (Hence the terms of “clad” and “coated” and “bonded” are used interchangeably herein.) The clad material can be selected from the non-limiting choices of copper-clad steel, copper-coated steel, copper-bonded steel, copper-clad graphite, copper-coated graphite, copper-clad iron, copper-clad aluminum, titanium-clad copper, titanium-coated copper, silver-clad copper, aluminum-clad steel, bronze-clad steel, titanium-clad steel, and nickel-clad steel.

As a non-limiting embodiment of this teaching, copper-clad steel (CCS) is used to make a reinforced electrode for a vacuum interrupter. CCS has been in existence for many decades, widely used in many applications, manufactured in very large quantities, and available in a large variety of sizes, at economic commodity prices. The unique situation of a low or no continuous current-carrying requirement on the vacuum interrupter for these two groups of vacuum switching devices, or any other existing or future vacuum switching devices applied in such a unique situation, makes it a viable solution to use commercial CCS to manufacture the electrodes, to achieve large saving in cost. An additional benefit of using CCS is that an externally threaded bolt can be machined right out of the steel core, thereby avoiding the need to machine and clean a blind hole in the electrode for external mechanical connection. Even if an internal-thread is preferred for external mechanical connection, one that is machined on the steel core still offers the advantage of not needing a supplementary helicoil insert, as often is required for an internal-thread that is machined on a soft OFHC electrode in a vacuum interrupter.

As another aspect of the disclosed concept, a method is provided to make a reinforced vacuum interrupter electrode from a commercial clad composite raw material starting bar stock, to achieve great cost savings.

### BRIEF DESCRIPTION OF THE DRAWINGS

A full understanding of the disclosed concept can be gained from the following description of the preferred embodiments when read in conjunction with the accompanying drawings in which:

FIG. 1 is a sectional view of a vacuum interrupter in accordance with the prior art, wherein the portion to the left of the vertical axis shows the closed position and the portion to the right of the vertical axis shows the open position;

FIG. 2 is a sectional view of a vacuum interrupter of a first embodiment in accordance with the disclosed concept, of employing reinforcement to the soft copper electrode;

FIG. 3 is a sectional view of a vacuum interrupter of a second embodiment in accordance with the disclosed concept, of employing copper-clad steel to make a reinforced electrode;

FIG. 3A is a sectional view of a vacuum interrupter of a third embodiment in accordance with the disclosed concept, of brazing additional booster pieces to the vacuum interrupter in FIG. 3;

FIG. 3B is a cross-section of a reinforced electrode made from a clad composite material;

FIG. 4 is a sectional view of a vacuum interrupter of a fourth embodiment in accordance with the disclosed concept, of employing titanium-clad copper to make a reinforced electrode;

FIG. 5 is a sectional view of a vacuum interrupter of a fifth embodiment in accordance with the disclosed concept, of employing copper-clad graphite to make a reinforced electrode;

FIG. 6 is an isometric view of a vacuum interrupter, of a sixth embodiment in accordance with the disclosed concept, of employing a clad composite of a hexagonal cross section to make a reinforced electrode, wherein an azimuthal quadrant of all the components except for the electrodes, the contacts, the contact shields, and the copper booster is removed for better illustration; and

FIG. 7 is a pictorial flow-chart illustrating the steps of making reinforced electrodes from a clad composite raw material starting bar stock.

### DESCRIPTION OF THE PREFERRED EMBODIMENTS

As employed herein, the singular forms “a,” “an,” and “the” include plural references unless the context clearly dictates otherwise. Unless defined otherwise, all technical and scientific terms used in this document have the same meanings as commonly understood by one of ordinary skill in the art. As employed in this document, the term “comprising” (or “comprises”) means “including (or includes), but not limited to.”

As employed herein, the term “vacuum envelope” means an envelope employing a partial vacuum therein. As employed herein, the term “partial vacuum” means a space (e.g. within a vacuum envelope) partially exhausted (e.g. to the highest degree practicable; to a relatively high degree; to a degree suitable for use in a vacuum switching apparatus application) by a suitable mechanism (e.g. without limitation, a vacuum furnace).

The disclosed concept is described in association with vacuum interrupters, although one aspect of the disclosed concept, of making a reinforced electrode from a clad composite starting stock, is applicable to a wide range of vacuum switching apparatus. Non-limiting applications for vacuum switching apparatus include a recloser, a fault-interrupter, a circuit breaker, a generator circuit breaker, a load break switch (LBS), a contactor, a low voltage (LV) switching apparatus, a medium voltage (MV) switching apparatus, a high voltage (HV) switching apparatus, and a vacuum electrical switching apparatus, for an alternate current (AC) or a direct current (DC) power system.

As employed herein, the term “electrode” means an electrical current conductor; one end of the electrode is connected permanently to an electrical contact inside the vacuum envelope of a vacuum interrupter, directly or via one or more intermediate components; the opposite end of the electrode, in the direction of the overall current flow through it and through the vacuum interrupter, is connected, permanently or removably, directly or via one or more intermediate components, to the power busbar external to the vacuum interrupter. This definition will further be exemplified in the vacuum interrupters to be described in the following.

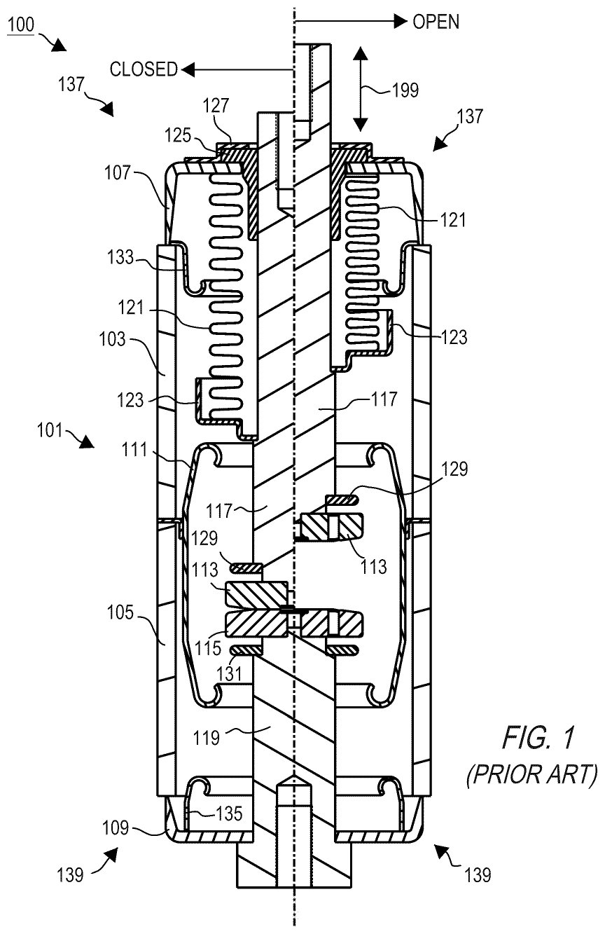

FIG. 1 shows a typical vacuum interrupter 100 for a recloser or a fault-interrupter, in accordance with the prior art. It includes a vacuum envelope 101 comprising two tubular insulator members 103 and 105 caped with two metal end-caps 107 and 109. Inside the vacuum envelope 101 is a shield assembly 111, which protects the internal walls of the insulator members 103 and 105 against deposit of metal vapor generated by arcing activities between the pair of separable electrical contacts, the movable contact 113 and the fixed contact 115. Two electrodes 117 and 119 connect the two contacts to the busbars (not shown) of the external electrical power line the switching device employing the interrupter is protecting. The movable electrode 117 also connects the movable contact 113 to an external driving mechanism (not shown) to move it in the direction of the arrow 199 between a closed position (left side of the vertical axis of FIG. 1) in electrical contact with the fixed contact 115, and an open position (right side of the vertical axis of FIG. 1) spaced apart from the fixed contact 115. A bellows 121 facilitates this transfer of motion from the exterior to the interior of vacuum envelope 101. A bellows shield 123 protects the thin-walled bellows from any molten spatter originating from arcing activities in between the opening contacts. A plastic bushing 125 guides the axial motion of the movable electrode 117, while a bushing retainer 127 secures bushing 125 to end-cap 107. For a TMF (transverse magnetic field) type of vacuum interrupter shown in FIG. 1, often but not always there are the contact shields 129 and 131 that further catch metal vapor and splashing. Often there are also the end-shields 133 and 135 that protect the triple junctions of the metal-to-insulator joints. Commonly in the field the metal parts are grouped into two ends, the movable end 137 and the fixed end 139, separated by the insulator members 103 and 105. Movable end 137 (the upper or top end in FIG. 1) includes parts 107, 113, 117, 121, 123, 127, 129, and 133. Fixed end 139 (the lower or bottom end in FIG. 1) includes parts 109, 115, 119, 131, and 135. The tubular insulator members 103 and 105 of the vacuum envelope define a common longitudinal central axis, the vertical axis of FIG. 1, for vacuum interrupter 100.

Electrodes 117 and 119 perform the dual duties of electrical and mechanical connections of the contacts to outside the vacuum interrupter. For most vacuum interrupters the electrodes are sized according to the continuous current-carrying parameter for the devices in which they are used. For the group of reclosers and fault-interrupters rated for 200 A or below of continuous current-carrying, or for a shunt vacuum interrupter not required to carry any continuous current, the diameter of the electrode is instead dictated by the mechanical requirements, due to the softness of an OFHC copper electrode, as mentioned earlier. Too small an electrode risks bending when the vacuum interrupter is subjected to out of bound operating conditions. Once bent, a movable electrode cannot move freely through the bushing (125), and in the worst case can be completely seized against the bushing, leading to failure of the proper functioning of the recloser or fault-interrupter.

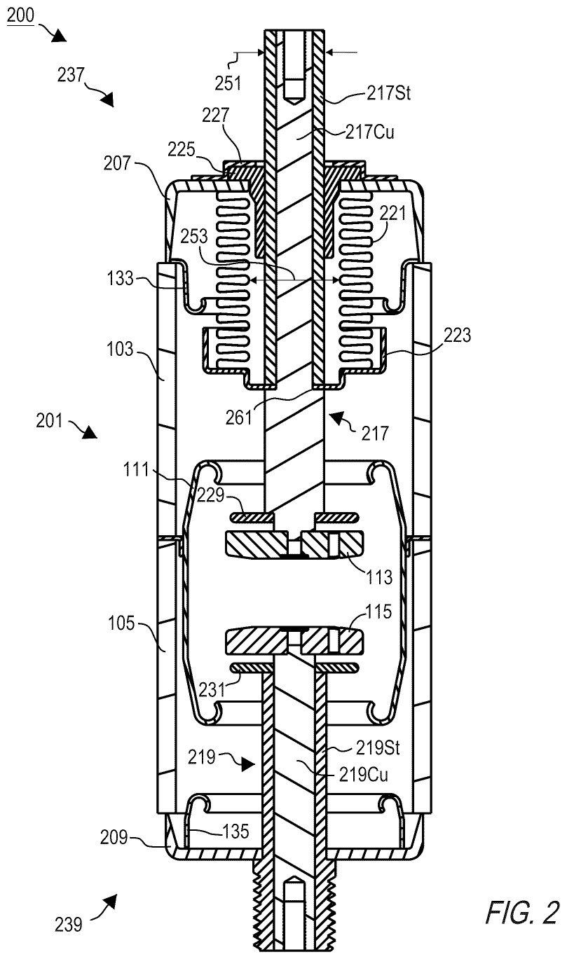

As a non-limiting embodiment of the disclosed concept, FIG. 2 shows a vacuum interrupter 200 in which both the movable electrode 217 and the fixed electrode 219 have been reinforced, simply by adding a sleeve, 217St and 219St respectively, made of a strong material such as a stainless steel or a carbon steel or an iron, over the soft copper core 217Cu and 219Cu respectively. (For very low continuous current ratings, the material compositions may be swapped, with the sleeve being copper and the inner core being steel.) With the reinforcement, the portion of electrode 217 inside the bellows can be of a smaller diameter 251 than that of electrode 117 in FIG. 1, without concern for electrode bending. This in turn allows the inside diameter (ID) 253 of the convolutions of the bellows to be smaller (than that of the bellows in FIG. 1). As used in a vacuum interrupter described herein, the bellows constantly experiences an atmospheric force exerted by the high-pressure side atmosphere over its vacuum side. The magnitude of this force increases with the bellows' inside diameter 253 (and its outside diameter). The driving mechanism of the switching device has to act against this atmospheric force to move the movable contact from the closed position into the open position. As a result of the reduction of the movable mass because of a smaller diameter electrode and the use of the less dense steel in place of copper, combined with a lower atmospheric force, the need for the power of the driving mechanism can be significantly reduced.

The composite structure of the copper core 217Cu and the steel sleeve 217St as shown in FIG. 2 is formed in situ, as reflected by the copper core 217Cu not having a uniform diameter along its entire length (along the axis of the vacuum interrupter), and a step 261 machined on it. There is a very thin layer of braze filler (not shown) in the joint or interface between 217Cu and 217St. The joining together of them, by melting the braze filler material, is carried out in the same brazing furnace cycle as that for the joining of the other components of the contact, the bellows and others. To ensure leak-tightness of the joint, both sleeve 217St and core 217Cu need to be machined to a tight tolerance in straightness and diameter (to have a good capillary force to draw and spread out the molten braze filler across the entire faying interface between the two components being brazed together). And they both need to be cleaned thoroughly before being loaded into a vacuum furnace.

This is where another aspect of the disclosed concept, the use of a commercial clad composite raw material, comes in. As employed herein, the term “clad” (or “cladding”) means to manufacture a composite material by permanently bonding two dissimilar component materials in an industrial scale, as a raw material manufacturing process, not the mere forming of a composite structure comprising the two dissimilar materials bonded together, and particularly not the forming of the composite structure in situ in the fabrication process of a device employing one such composite structure. Correspondingly, the term “clad composite raw material” as employed herein, has its dissimilar components permanently bonded together in the raw material stage, with at least one dimension, for example length, many (at least 3) times larger than the final corresponding dimension of a part, such as an electrode, to be made from such a clad composite raw material.

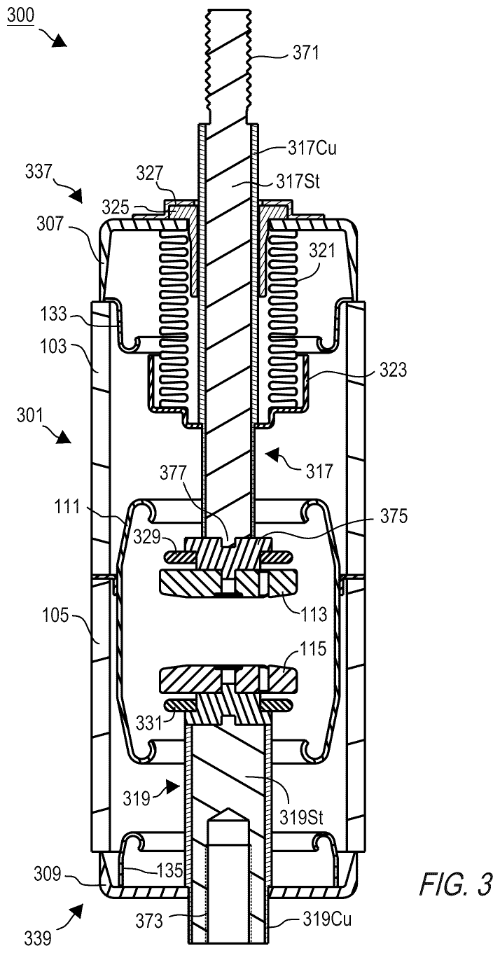

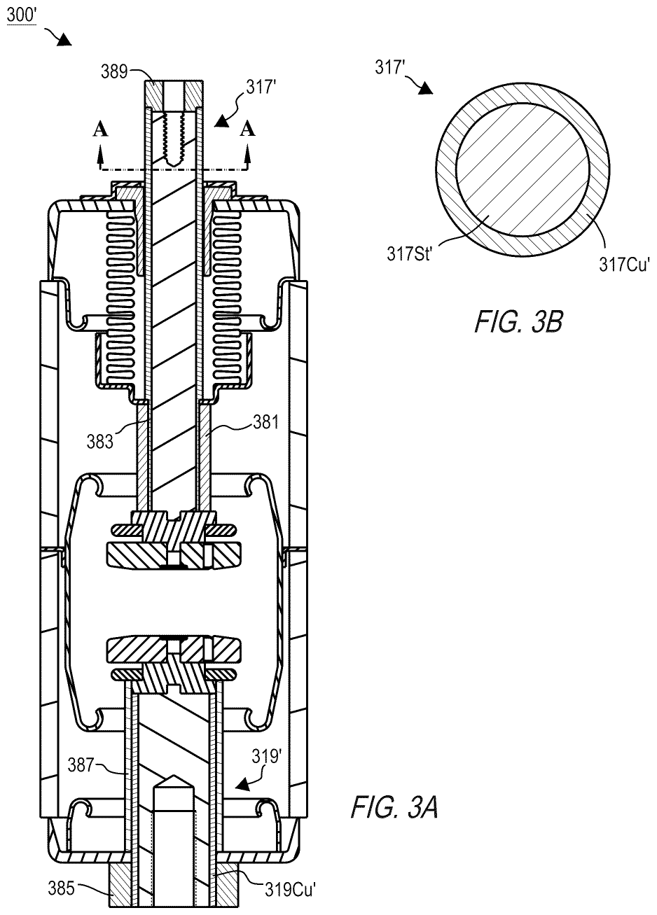

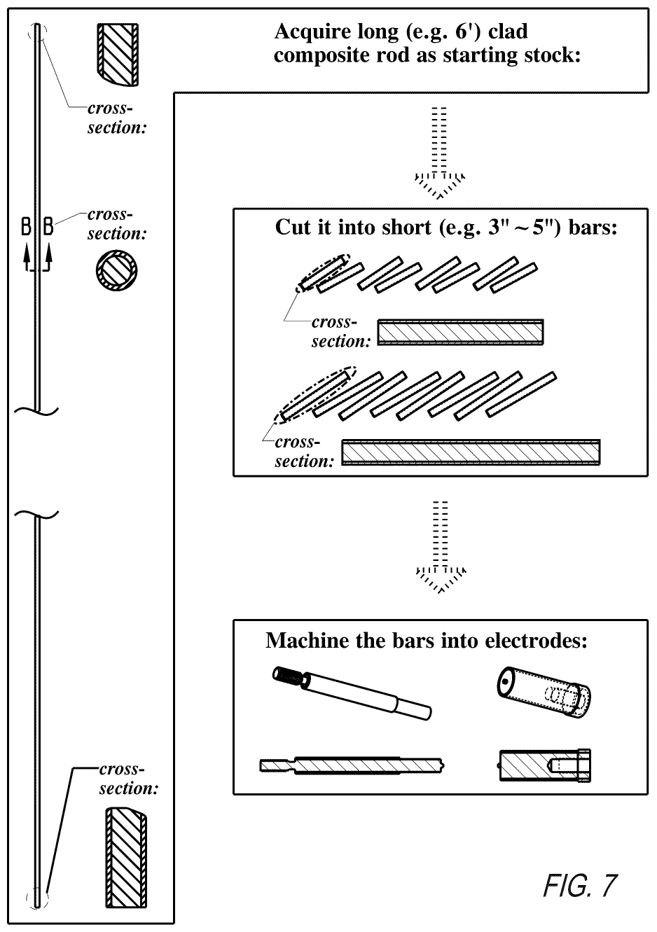

Referring to FIG. 3, it shows a vacuum interrupter 300 as another embodiment in accordance with the disclosed concept. Its movable electrode 317 and fixed electrode 319 are both machined from clad composite raw material stock bars, with the copper outer layer 317Cu and the reinforcing core 317St already pre-bonded before machining (and brazing), as reflected by the uniform diameter of the inner core component (317St) along the entire length (see also FIG. 7).

There are many commercial clad materials available. One non-limiting example is the copper-clad steel (CCS). As mentioned earlier, CCS is manufactured and consumed in large quantities for grounding rods or grid meshes and in electric power transmission, at a price level much lower than that of OFHC copper. Certainly, its relatively low electrical conductivity makes it not suitable for high continuous current-carrying applications. But for a vacuum interrupter used in these two particular groups of reclosers and fault-interrupters with low continuous current-carrying requirement and shunt vacuum interrupters with no continuous current-carrying requirement at all, using CCS to make reinforced electrodes is a viable option, with large financial benefits.

One additional advantage of using a steel core is that an externally threaded bolt (371 in FIG. 3) can be machined right out of the steel core 317St itself, for external mechanical connection. Even if an internal-thread is preferred, one that is machined on the steel core, such as 373 shown in fixed electrode 319, still offers the advantage of not needing a supplementary helicoil insert (not shown), as often is required for an internal-thread machined on a soft OFHC electrode.

Note that in FIG. 3, electrode 317 is connected to contact 113 via a copper connector piece 375. The connection between 317 and 375 is a serial connection, as opposed to the parallel connection between 317Cu and 317St, with regard to the flow of current through the vacuum interrupter, between the movable end 337 and the fixed end 339. In other words, 317 and 375 carry the current in serial, while 317Cu and 317St carry the current parallelly. (It should further be stated that the discussion herein about serial vs parallel current-carrying disregards the current flow in small local regions, such as 377 in FIG. 3, where a small protrusion from one component 317St is mated with a corresponding recess in the opposite component 375, for coaxial alignment between them; the current-carrying fashion, serial or parallel, refers to the overall current flow in the majority of the body of a component, as is commonly understood by one skilled in the art.)

If so desired, various electrical booster pieces, such as the copper sleeve 381 shown in FIG. 3A, can be simply added, via brazing, over the necked-down portion 383 of the clad electrode 317′, to raise the continuous current-carrying capability of the vacuum interrupter 300′ (which is another non-limiting embodiment of the disclosed concept). These booster pieces can be of different wall thicknesses, to tune the continuous current-carrying capability to suit different rating levels. They can also cover the entire length of the clad electrode, as opposed to just the necked-down portion. And they can also be designed, as shown by an example of the copper piece 385, such that, in order to facilitate a braze joint, a necked-down (as shown in the fixed electrode outer layer 319Cu in FIG. 3) is not necessary on the outer clad layer 319Cu′ of electrode 319′. Similarly, a mechanical booster sleeve (such as 387) made of a steel (stainless steel or low carbon steel) can also be added, via brazing if permanent bonding is desired, at strategic locations, inside or outside the vacuum envelope, to improve the mechanical performance of the vacuum interrupter, if necessary. These booster pieces, electrical or mechanical, can effectively compensate for the fact that, unlike an in situ brazed-on outer layer, the outer layer in a cylindrical or bar shape clad composite raw material is typically thin due to the nature of the cladding processes. As is illustrated in FIG. 3B, which is a cross-section (shown in 3× magnification) of 317′ taken along line A-A shown in FIG. 3A, the area of the outer layer (317Cu′) of a clad composite raw material typically amounts to no more than 40% of the total cross-sectional area, i.e. the areas of 317Cu′ and 317St′ combined.

For the busbar connection, if it is preferred to have a butting connection to the flat end surface of the movable electrode, rather than to its cylindrical side surface, a washer or donut piece of copper connector such as 389 (shown in FIG. 3A) may be added, again via brazing, if necessary.

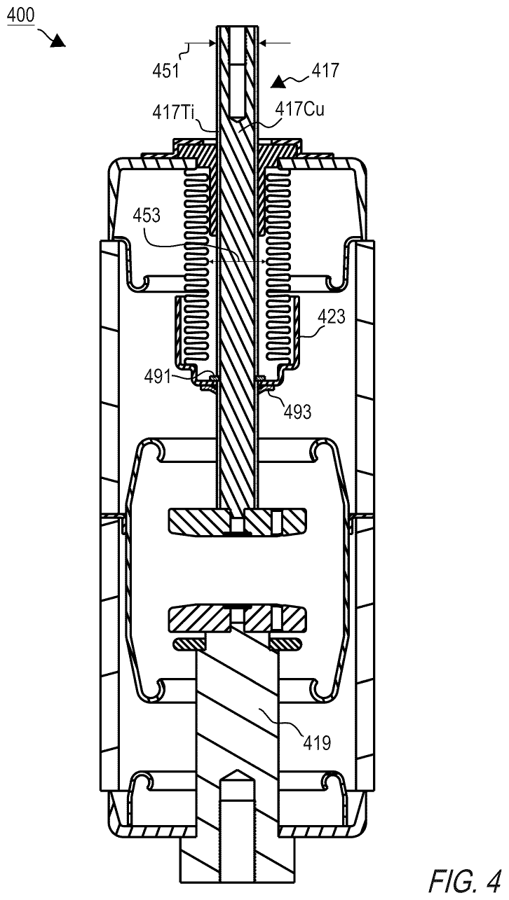

Another commercially available clad material is titanium-clad copper. If achieving the smallest moving mass and lowest atmospheric force on the bellows is the ultimate objective, then using the strong and yet light weight, albeit expensive, titanium offers a solution. FIG. 4 shows one such vacuum interrupter 400, as another non-limiting embodiment of the disclosed concept. Its movable electrode 417 is a composite made of a slim copper core 417Cu clad with a thin titanium outer layer 417Ti. Note that the diameter 451 of such a titanium reinforced copper electrode, and the ID 453 of the bellows around it, are smaller than even 251 and 253, respectively, shown in FIG. 2 for vacuum interrupter 200. (Note also that the method as described in U.S. Pat. No. 6,043,446, employing a snap ring 491 and a rotor clip 493, is used to facilitate the braze joint with the bellows shield 423. Alternatively, a booster piece, of a steel for further mechanical boosting or of copper for electrical boosting, such as 381 shown in FIG. 3A, can be used.) If it is necessary to compensate for the low heat conduction capability of the skinny movable electrode, the fixed electrode can be left being entirely made of a beefy OFHC copper, as is shown by electrode 419 in FIG. 4, to maximize its heat conduction capability to help carry away the heat generated at the mating contacts.

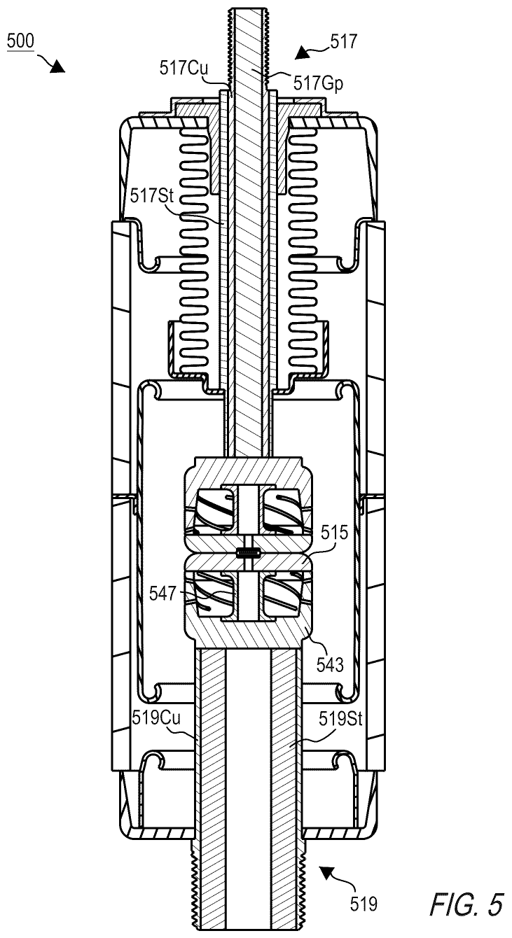

Yet another commercially manufactured clad material is copper-clad graphite. FIG. 5 shows a vacuum interrupter 500, as another non-limiting embodiment of the disclosed concept. Its movable electrode 517 is a composite of three coaxial layers, with the copper layer 517Cu sandwiched in between an outer steel layer 517St and a graphite core 517Gp. The graphite offers a very light weight, the copper carries the majority of current, and the steel provides the toughness. A copper-clad graphite starting stock can be used to make the two inner layers, and the steel sleeve can be either commercially clad, or brazed on in situ in the vacuum interrupter production line.

As fixed electrode 519 shows, a clad composite raw material does not have to have a solid core, rather it can have a clad layer 519Cu over a tubing 519St inside. (The vacuum interrupter in this embodiment of the disclosed concept is of the AMF, axial magnetic field, type, having an AMF generating coil 543 and the center support pillar 547 in between electrode 519 and contact 515.)

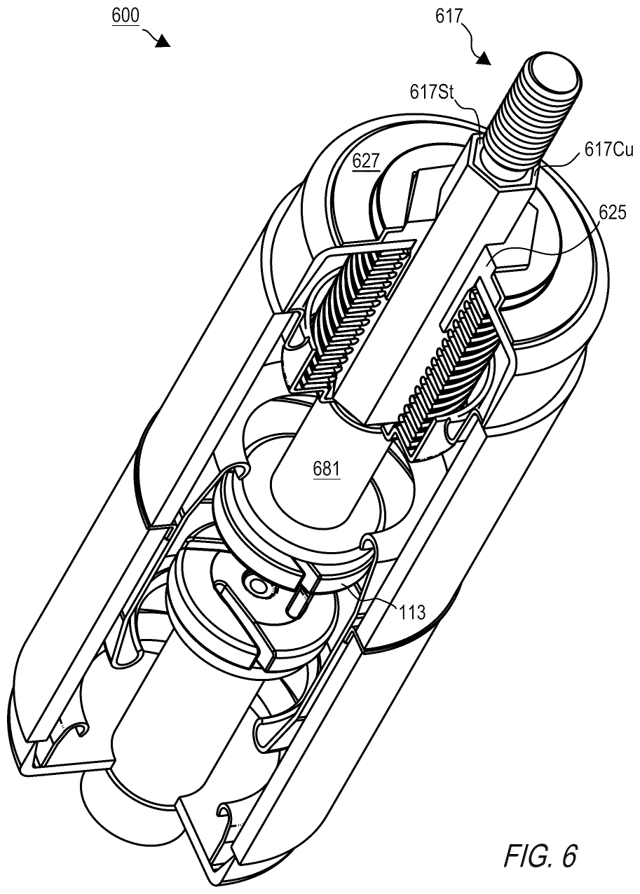

Also, the cross-sectional shape of the clad raw material does not have to be circular. Commercial clad materials such as CCS with non-circular cross-section shapes are available, and may be used to some advantage. For example, the movable electrode 617 of the vacuum interrupter 600 in FIG. 6, which is another non-limiting embodiment of the disclosed concept, has a hexagon shape cross-section, consisting of an outer layer 617Cu clad over the inner core 617St. (It is connected to contact 113 via a copper booster piece 681.) Working in conjunction with a bushing 625 and a bushing retainer 627 each with a corresponding center through-hole of a hexagon shape, such a clad composite electrode with a non-circular cross-section offers an anti-twisting function, to protect the bellows from being subjected to a twisting force that can lead to premature failure of the thin-walled bellows. Such anti-twisting protection is needed when it is difficult to securely hold the movable electrode in (azimuthal) position while making a rotational threaded engagement to it.

Another commercially available clad material is copper-clad aluminum. Aluminum is not very friendly to existing brazing processes employed in the manufacturing of vacuum interrupters. Coupled with its potential fire hazard, copper-clad aluminum may not be an attractive option to make a reinforced electrode for a vacuum interrupter, for now. It is nevertheless a possibility.

Referring to FIG. 7 now, a pictorial flow-chart is provided to illustrate the method to machine a reinforced electrode from a clad composite starting stock, with its two components already permanently bonded together. A characteristic of a cylindrical or bar-shape clad composite is that it has a uniform cross-sectional structure along its entire long length, from one end to the other. Usually the outer layer is relatively thin, at most amounting to 40% of the total cross-sectional area of the composite (as illustrated in FIG. 3B). Such a bar stock is then cut into short pieces. At this stage the short bar pieces also still have a uniform cross-sectional structure along their entire length, as illustrated in FIG. 7. These short bars are then machined into the final geometry to add features such as a hole or a step or threads of the reinforced composite electrode. (Alternatively, a bar feeder for the CNC machine may be used to directly machine the composite electrode from the bar stock.)

Cladding methods used to form the clad material include but are not limited to: electroplating, electroless plating, explosive welding, roll bonding, extruding, hot isostatic pressing, laser cladding, thermal spraying, and diffusion bonding. The clad material can be selected from the non-limiting choices of copper-clad steel, copper-bonded steel, copper-coated steel, copper-clad graphite, copper-clad iron, copper-clad aluminum, titanium-clad copper, titanium-coated copper, silver-clad copper, aluminum-clad steel, bronze-clad steel, titanium-clad steel, and nickel-clad steel.

For the ease of illustration and economy of disclosure, only vacuum interrupters of the TMF and the AMF types are shown in the exemplary embodiments of FIGS. 1-7. However, it will be understood that a reinforced electrode made from a clad composite starting stock can be used in any known or suitable combination or alternative arrangement with any known or suitable alternative vacuum switching apparatus therefor, without departing from the scope of the disclosed concept. For example and without limitation, it can be used in a vacuum interrupter with a pair of butt contacts, or a hybrid vacuum interrupter of the TMF and AMF interrupting principles, or a vacuum switching apparatus having two movable ends rather than the aforementioned arrangement of a movable end and a fixed end, or a vacuum switching apparatus having more than two contacts such as a 3-position vacuum switch. It can also be used to make a bundle of electrodes for a vacuum interrupter with a very high continuous current requirement, as described in U.S. Pat. No. 8,710,389. For applications involving a high frequency power system such as in aerospace, or for DC switching that employs artificial high frequency current zeros for interruption, a reinforced electrode made from a clad material may also be a good solution, as current-carrying at a high frequency is concentrated on the outer skin layer of an electrode. As technology advances in both vacuum interruption and cladding material manufacturing, new ways to apply a vacuum interrupter may evolve, as well as new clad composite material systems. Various modifications and alternatives to the specific embodiments could be developed in light of the overall teachings of the disclosed concept which is to be given the full breadth of the claims appended and any and all equivalents thereof.

1. An electrode for a vacuum interrupter for a recloser or fault-interrupter with a continuous current-carrying requirement of 200 amperes or below of AC current or a vacuum switching device with no continuous current-carrying requirement, said vacuum interrupter comprising a vacuum envelope of a generally tubular shape, and at least one electrical contact inside said vacuum envelope,
wherein said generally tubular vacuum envelope defines a longitudinal central axis for said vacuum interrupter,
wherein said electrode comprises one monolithic piece made of copper of at least 95 wt. % purity, one end of said copper piece connected permanently to said at least one contact, directly or via one or more intermediate components, and an opposite end along said axis of said copper piece connected, permanently or removably, directly or via one or more intermediate components, to the power busbar external to said vacuum interrupter,
wherein said copper piece has a length defined as its extent along said axis, wherein for at least 50% of said length of said copper piece, said electrode has a cross-sectional structure, when said cross-section is taken at any plane perpendicular to said axis, comprising said copper piece and at least one second component, said at least one second component made of a non-copper material defined as containing no more than 10 wt. % copper, and said at least one second component abutting said copper piece with no gap or the smallest gap between them being no larger than 3 mm, and
wherein said copper piece and said at least one second component of said non-copper material are permanently joined together.

2. The electrode of claim 1, wherein the joint between said copper piece and said at least one second component of said non-copper material does not contain any braze filler material. That is, said joint is not a brazed joint. That is, said copper piece and said at least one second component of said non-copper material are joined together not by a brazing method.

3. The electrode of claim 1, wherein said copper piece and said at least one second component are coaxial and coextensive along said axis of said vacuum interrupter.

4. The electrode of claim 3, wherein said non-copper material is selected from the group consisting of stainless steel, carbon steel, low-alloy steel, electrogalvanized steel, high carbon steel, pure iron, electrical steel or iron, soft magnetic iron, aluminum, titanium, and graphite.

5. The electrode of claim 3, wherein the area of said outer layer of said cross-sectional structure is no more than 40% of the total area of said electrode, in said cross-sectional structure.

6. An electrode for a vacuum interrupter, said vacuum interrupter comprising a vacuum envelope of a generally tubular shape, and at least one electrical contact inside said vacuum envelope,
wherein said tubular vacuum envelope defines a longitudinal central axis for said vacuum interrupter,
wherein said electrode comprises one monolithic piece made of copper of at least 95 wt. % purity, one end of said copper piece connected permanently to said at least one contact, directly or via one or more intermediate components, and the opposite end along said axis of said copper piece connected, permanently or removably, directly or via one or more intermediate components, to the power busbar external to said vacuum interrupter, and
wherein said copper piece comprises at least one portion wherein it is clad, as defined in the specification, with at least one second component made of a second material, said at least one second component and said copper piece being coaxial and coextensive along said axis of said vacuum interrupter.

7. The electrode of claim 6, wherein there is no braze filler in the cladding interface between said monolithic copper piece and said at least one coaxial and coextensive second component made of said second material.

8. The electrode of claim 7, wherein said second material is selected from the group consisting of stainless steel, carbon steel, low-alloy steel, electrogalvanized steel, high carbon steel, pure iron, electrical steel or iron, soft magnetic iron, aluminum, titanium, and graphite.

9. The electrode of claim 7, wherein said monolithic copper piece and/or said at least one second component of said second material is a tubing.

10. The electrode of claim 7, wherein said portion of said electrode has a cross-sectional shape, when said cross-section is taken at a plane perpendicular to said axis of said vacuum interrupter, of either a circle, or a non-circular geometry such as a hexagon or octagon or a square.

11. The electrode of claim 7, wherein the area of the outer layer is no more than 40% of the total area of said electrode, in a cross-section taken at a plane perpendicular to said axis of said vacuum interrupter, in said portion of said electrode.

12. The electrode of claim 11, wherein said second material is selected from the group consisting of stainless steel, carbon steel, low-alloy steel, electrogalvanized steel, high carbon steel, pure iron, electrical steel or iron, soft magnetic iron, aluminum, titanium, and graphite.

13. The electrode of claim 6, wherein said electrode is further brazed to an outer copper booster sleeve, said outer copper booster sleeve being coaxial along said axis with said electrode.

14. A method of making a composite electrode for a generally tubular vacuum interrupter, said tubular vacuum interrupter having a longitudinal central axis, said electrode having at least two components made of dissimilar materials, said two components being coaxial and coextensive along said axis, and said two components both carrying parallelly the current flowing through said vacuum interrupter, comprising:
acquiring a clad composite raw material comprising said at least two components made of said dissimilar materials permanently bonded together, wherein said clad composite raw material is defined in the specification,
using said clad composite raw material as the starting stock, and
machining said composite electrode from said clad composite raw material starting stock.

15. The method of claim 14, wherein said clad composite raw material is manufactured by a method selected from the group consisting of: electroplating, electroless plating, explosive welding, roll bonding, extruding, hot isostatic pressing, laser cladding, thermal spraying, and diffusion bonding.

16. The method of claim 14, wherein said clad composite raw material is selected from the group consisting of copper-clad steel, copper-bonded steel, copper-coated steel, copper-clad graphite, copper-coated graphite, copper-clad iron, copper-clad aluminum, titanium-clad copper, titanium-coated copper, silver-clad copper, aluminum-clad steel, bronze-clad steel, titanium-clad steel, and nickel-clad steel.

17. The method of claim 14 further comprising brazing an outer booster sleeve, of either copper for electrical boosting, or of a steel for mechanical boosting, to said electrode, said outer booster sleeve being coaxial and coextensive with said electrode along said axis.

18. The method of claim 14 further comprising machining an externally threaded portion out of the inner core of said clad raw material for said electrode.

19. A vacuum interrupter comprising the electrode as set forth in claim 6 and an evacuated vacuum envelope.

20. A vacuum switching device comprising the vacuum interrupter as set forth in claim 19 and a driving mechanism operatively connected with said vacuum interrupter.
